(19) United States
(12) Patent Application Publication
(10) Pub. No.: US 2026/0227069 A1
(43) Pub. Date: Aug. 6, 2026

(54) COMBUSTOR DOME COUPLED TO INNER AND OUTER COMBUSTOR LINERS

(71) Applicant: General Electric Company, Evendale, OH (US)

(72) Inventors: Michael Pudlo, Cincinnati, OH (US); Alexander Ennis, Cincinnati, OH (US); Nathan Richard Hermanson, Cincinnati, OH (US)

(21) Appl. No.: 19/043,593

(22) Filed: Feb. 3, 2025

(51) Int. Cl. F23R 3/00

(52) U.S. Cl. CPC F23R 3/60; F23R 3/002; F23R 2900/00012; F23R 2900/00017

(57) ABSTRACT

A combustor dome assembly includes an inner liner, an outer liner, a dome disposed on the inner liner and the outer liner, and a cowl connected to the inner liner and to the outer liner, wherein the dome is disconnected from the cowl and defines an annular surface facing the cowl, the annular surface extending from an outer diameter of the dome to an inner diameter of the dome.

### FIELD

The present disclosure relates to a combustor dome assembly for a gas turbine engine.

### BACKGROUND

Combustors in turbomachine engines receive a mixture of fuel and highly compressed air, which is ignited to produce hot combustion gases. These hot gases are used to provide a torque in a turbine to provide mechanical power and thrust. A typical combustor layout is at least partially constructed of metal, which has high weight, and which requires multiple wall construction and high levels of cooling to protect the combustor from extremely high temperatures. The expansion of the metal at high temperatures also creates gaps that interfere with airflow and reduces fuel efficiency.

### BRIEF DESCRIPTION OF THE DRAWINGS

A full and enabling disclosure of the present disclosure, including the best mode thereof, directed to one of ordinary skill in the art, is set forth in the specification, which makes reference to the appended figures, in which:

FIG. 1 is schematic view of a gas turbine engine.

FIG. 2 is a schematic view of a combustor dome assembly.

FIG. 3 is a forward looking aft view of the combustor dome assembly.

FIG. 4 is a forward looking aft view of another combustor dome assembly.

FIG. 5 is a forward looking aft view of another combustor dome assembly.

### DETAILED DESCRIPTION

Reference will now be made in detail to present embodiments of the disclosure, one or more examples of which are illustrated in the accompanying drawings. The detailed description uses numerical and letter designations to refer to features in the drawings. Like or similar designations in the drawings and description have been used to refer to like or similar parts of the disclosure.

The word “exemplary” is used herein to mean “serving as an example, instance, or illustration.” Any implementation described herein as “exemplary” is not necessarily to be construed as preferred or advantageous over other implementations. Additionally, unless specifically identified otherwise, all embodiments described herein should be considered exemplary.

The singular forms “a”, “an”, and “the” include plural references unless the context clearly dictates otherwise.

The terms “outer” and “inner” refer to relative positions within a turbomachine engine, from a centerline axis of the engine. For example, outer refers to a position further from the centerline axis and inner refers to a position closer to the centerline axis.

As used herein, the terms “first,” “second,” “third,” and other ordinals are used to distinguish one component from another and are not intended to signify location or importance of the individual components.

In this context, a “metal” refers to a pure metal or a metal alloy, and does not include other compounds including metallic elements, such as metal oxides (such as aluminum oxide, titanium oxide, etc.) or metal salts (such as sodium chloride).

As used herein, ceramic matrix composite or “CMCs” refers to composites comprising a ceramic matrix reinforced by ceramic fibers. Some examples of CMCs acceptable for use herein can include, but are not limited to, materials having a matrix and reinforcing fibers comprising oxides, carbides, nitrides, oxycarbides, oxynitrides and mixtures thereof. Examples of non-oxide materials include, but are not limited to, CMCs with a silicon carbide matrix and silicon carbide fiber (when made by silicon melt infiltration, this matrix will contain residual free silicon); silicon carbide/silicon matrix mixture and silicon carbide fiber; silicon nitride matrix and silicon carbide fiber; and silicon carbide/silicon nitride matrix mixture and silicon carbide fiber. Furthermore, CMCs can have a matrix and reinforcing fibers comprised of oxide ceramics. Specifically, the oxide-oxide CMCs may be comprised of a matrix and reinforcing fibers comprising oxide-based materials such as aluminum oxide (Al₂O₃), (silicon dioxide (SiO₂), aluminosilicates, and mixtures thereof. Accordingly, as used herein, the term “ceramic matrix composite” includes, but is not limited to, carbon-fiber-reinforced carbon (C/C), carbon-fiber-reinforced silicon carbide (C/SiC), and silicon-carbide-fiber-reinforced silicon carbide (SiC/SiC). In one embodiment, the ceramic matrix composite material has increased elongation, fracture toughness, thermal shock resistance, and anisotropic properties as compared to a (non-reinforced) monolithic ceramic structure.

The present disclosure is generally related to combustor dome assemblies for gas turbine engines. The use of CMC materials is desirable in combustor design because CMC materials have far higher heat capacity than metal. Though some combustor designs have utilized CMC for portions of the combustor, these still rely on metal for the dome and other combustor components. The advantages of a CMC design for the dome include, but are not limited to, reduced cooling, weight reduction, and shorter combustor length, due to replacement of the heavier metal components and simplified internal design. The inclusion of CMC materials also potentially provides improved airflow control by eliminating attachment gaps between the dome and the liners, reduced weight by eliminating additional deflectors, and reduced cooling on the dome. The dome is typically fixed to a metal component, such as a cowl, which may introduce thermal gradients and thermal stresses during operation.

Forming a dome of CMC material with a substantially flat surface spaced from the cowl reduces an overall thickness of the dome, reducing thermal gradients and thermal stresses. To secure the dome to liners of the combustor dome assembly, a pressurized seal is formed that presses the dome against the liners. Specifically, the dome is designed with a forward portion and an aft portion, and the forward portion has a larger annular shape than the aft portion. An increased air pressure upstream of the combustion chamber holds the forward portion of the dome against the liners, such that the dome uses fewer or no fasteners to attach to the cowl. In such a form, the overall profile of the dome is reduced and the combustor dome assembly may operate with fewer thermal stresses.

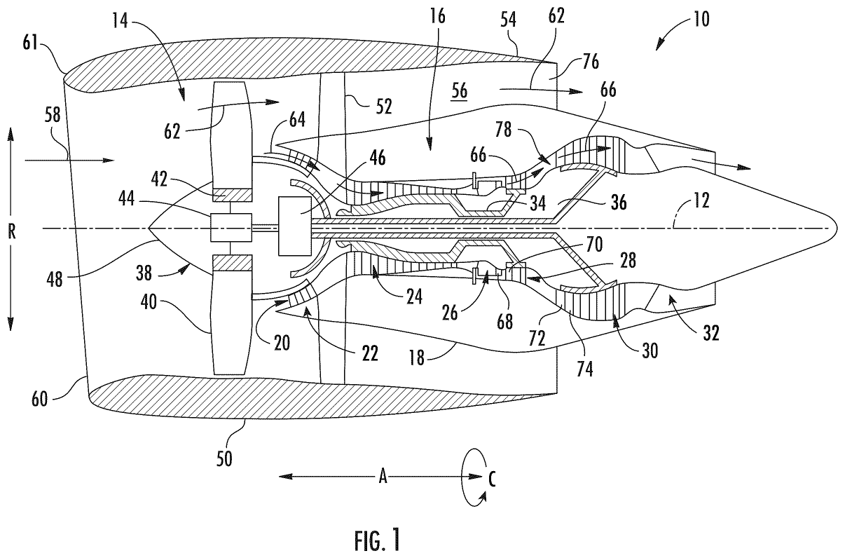

Referring now to the drawings, wherein identical numerals indicate the same elements throughout the figures, FIG. 1 is a schematic cross-sectional view of a gas turbine engine in accordance with an exemplary embodiment of the present disclosure. More particularly, for the embodiment of FIG. 1, the gas turbine engine is a high-bypass turbofan jet engine, sometimes also referred to as a “turbofan engine.” As shown in FIG. 1, the gas turbine engine 10 defines an axial direction A (extending parallel to a longitudinal centerline 12 provided for reference), a radial direction R perpendicular to the longitudinal centerline 12, and a circumferential direction C extending about the longitudinal centerline 12. In general, the gas turbine engine 10 includes a fan section 14 and a turbomachine 16 disposed downstream from the fan section 14 in the axial direction A.

The exemplary turbomachine 16 depicted generally includes a substantially tubular outer casing 18 that defines an annular inlet 20. The outer casing 18 encases, in serial flow order, a compressor section including a booster or low pressure (LP) compressor 22, a high pressure (HP) compressor 24, and a core duct between the LP compressor 22 and the HP compressor 24; a combustion section 26; a turbine section including a high pressure (HP) turbine 28 and a low pressure (LP) turbine 30; and a turbomachine exhaust nozzle 32. A high pressure (HP) shaft 34 (which may additionally or alternatively be a spool) drivingly connects the HP turbine 28 to the HP compressor 24. A low pressure (LP) shaft 36 (which may additionally or alternatively be a spool) drivingly connects the LP turbine 30 to the LP compressor 22. The compressor section, combustion section 26, turbine section, and turbomachine exhaust nozzle 32 together define a working gas flowpath 37.

For the embodiment depicted, the fan section 14 includes a fan 38 having a plurality of fan blades 40 coupled to a disk 42 in a spaced apart manner. As depicted, the fan blades 40 extend outwardly from disk 42 generally along the radial direction R. Each fan blade 40 is rotatable relative to the disk 42 about a pitch axis P by virtue of the fan blades 40 being operatively coupled to a suitable pitch change mechanism 44 configured to collectively vary the pitch of the fan blades 40, e.g., in unison. The gas turbine engine 10 further includes a power gear box 46, and the fan blades 40, disk 42, and pitch change mechanism 44 are together rotatable about the longitudinal centerline 12 by LP shaft 36 across the power gear box 46. The power gear box 46 includes a plurality of gears for adjusting a rotational speed of the fan 38 relative to a rotational speed of the LP shaft 36, such that the fan 38 may rotate at a more efficient fan speed.

Referring still to the exemplary embodiment of FIG. 1, the disk 42 is covered by rotatable front hub 48 of the fan section 14 (sometimes also referred to as a “spinner”). The front hub 48 is aerodynamically contoured to promote an airflow through the plurality of fan blades 40. Additionally, the exemplary fan section 14 includes an annular fan casing or outer nacelle 50 that circumferentially surrounds the fan 38 and/or at least a portion of the turbomachine 16. It should be appreciated that the nacelle 50 is supported relative to the turbomachine 16 by a plurality of circumferentially-spaced outlet guide vanes 52 in the embodiment depicted. Moreover, a downstream section 54 of the nacelle 50 extends over an outer portion of the turbomachine 16 so as to define a bypass airflow passage 56 therebetween.

During operation of the gas turbine engine 10, a volume of air 58 enters the gas turbine engine 10 through an associated inlet 60 of the nacelle 50 and fan section 14. As the volume of air 58 passes across the fan blades 40, a first portion 62 of air is directed or routed into the bypass airflow passage 56 and a second portion 64 of air as indicated by an arrow is directed or routed into the working gas flowpath 37, or more specifically into the LP compressor 22. The ratio between the first portion 62 of air and the second portion 64 of air is commonly known as a bypass ratio. A pressure of the second portion 64 of air is then increased as it is routed through the HP compressor 24 and into the combustion section 26, where it is mixed with fuel and burned to provide combustion gases 66.

The combustion gases 66 are routed through the HP turbine 28 where a portion of thermal and/or kinetic energy from the combustion gases 66 is extracted via sequential stages of HP turbine stator vanes 68 that are coupled to the outer casing 18 and HP turbine rotor blades 70 that are coupled to the HP shaft 34, thus causing the HP shaft 34 to rotate, thereby supporting operation of the HP compressor 24. The combustion gases 66 are then routed through the LP turbine 30 where a second portion of thermal and kinetic energy is extracted from the combustion gases 66 via sequential stages of LP turbine stator vanes 72 that are coupled to the outer casing 18 and LP turbine rotor blades 74 that are coupled to the LP shaft 36, thus causing the LP shaft 36 to rotate, thereby supporting operation of the LP compressor 22 and/or rotation of the fan 38.

The combustion gases 66 are subsequently routed through the turbomachine exhaust nozzle 32 of the turbomachine 16 to provide propulsive thrust. Simultaneously, the pressure of the first portion 62 of air is substantially increased as the first portion 62 of air is routed through the bypass airflow passage 56 before it is exhausted from a fan exhaust nozzle 76 of the gas turbine engine 10, also providing propulsive thrust. The HP turbine 28, the LP turbine 30, and the turbomachine exhaust nozzle 32 at least partially define a hot gas path 78 for routing the combustion gases 66 through the turbomachine 16.

It should be appreciated, however, that the exemplary gas turbine engine 10 depicted in FIG. 1 is by way of example only, and that in other exemplary embodiments, the gas turbine engine 10 may have any other suitable configuration. For example, although the gas turbine engine 10 depicted is configured as a ducted gas turbine engine (i.e., including the outer nacelle 50), in other embodiments, the gas turbine engine 10 may be an unducted gas turbine engine (such that the fan 38 is an unducted fan, and the outlet guide vanes 52 are cantilevered from the outer casing 18).

Additionally, or alternatively, although the gas turbine engine 10 depicted is configured as a geared gas turbine engine (i.e., including the power gear box 46) and a variable pitch gas turbine engine (i.e., including a fan 38 configured as a variable pitch fan), in other embodiments, the gas turbine engine 10 may additionally or alternatively be configured as a direct drive gas turbine engine (such that the LP shaft 36 rotates at the same speed as the fan 38), as a fixed pitch gas turbine engine (such that the fan 38 includes fan blades 40 that are not rotatable about a pitch axis P), or both. It should also be appreciated, that in still other exemplary embodiments, aspects of the present disclosure may be incorporated into any other suitable gas turbine engine. For example, in other exemplary embodiments, aspects of the present disclosure may (as appropriate) be incorporated into, e.g., a turboprop gas turbine engine, a turboshaft gas turbine engine, or a turbojet gas turbine engine.

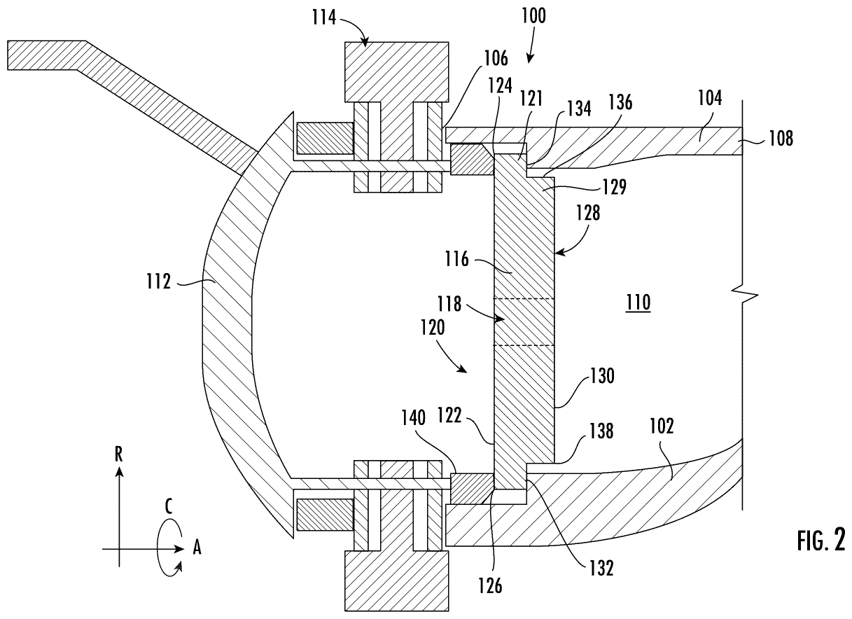

Now referring to FIG. 2, a schematic, cross-sectional view of a combustion section 26 in accordance with an exemplary embodiment of the present disclosure is provided. The combustion section 26 may be incorporated into an engine configured in a similar manner as the exemplary gas turbine engine 10 of FIG. 1.

The combustion section 26 includes a combustor dome assembly 100. The combustor dome assembly 100 includes an inner liner 102 and an outer liner 104. In this context, the “inner” liner 102 is positioned inward of the “outer” liner 104 in the radial direction R. For the embodiment depicted, the inner liner 102 and the outer liner 104 are formed of a ceramic matrix composite (CMC) material, as described above. In other forms, the inner liner 102 and the outer liner 104 may be formed of another material, such as a metal.

The combustor dome assembly 100 defines an axial direction A, a radial direction R, and a circumferential direction C. While the directions A, R, C, are generally defined relative to the inner liner 102, in the exemplary embodiment of FIG. 2, the directions A, R, align with the axial direction A, the radial direction R, and the circumferential direction C of the gas turbine engine 10 described above.

The combustor dome assembly 100 extends between a forward end 106 and an aft end 108 in the axial direction A. The inner liner 102 and the outer liner 104 define a combustion chamber 110 between the forward end 106 and the aft end 108 in which a fuel-air mixture combusts.

The gas turbine engine 10 includes a cowl 112. The cowl 112 is connected to the outer liner 104 and to the inner liner 102. Specifically, the cowl 112 is a structural member that connects CMC components (such as the inner and outer liners 102, 104) to other parts of the gas turbine engine 10. The cowl 112 assists in directing the flow of compressed air from the compressor section into the combustion chamber 110. The cowl 112 is formed of a metal, such as steel, including high-strength steel alloys with melting points exceeding 1000° F. The cowl 112 is fixed to the inner liner 102 and the outer liner 104 with a suitable fastener 114, such as a bolt or a pin joint. In FIG. 2, the cowl 112 is fixed to the inner liner 102 and the outer liner 104 with bolts and nuts.

The combustor dome assembly 100 includes a dome 116. The dome 116 forms a forward wall of the combustion chamber 110. The dome 116 is configured to assist in providing a flow of compressed air from the compressor section into the combustion chamber 110. The dome 116 is disposed on the inner liner 102 and the outer liner 104. In particular, the dome 116 is secured to the inner liner 102 and the outer liner 104 with a pressurized seal. That is, air pressure forward of the dome 116 is greater than air pressure in the combustion chamber 110, and the pressure difference drives the dome 116 onto the inner liner 102 and the outer liner 104. The dome 116 is formed of a CMC material.

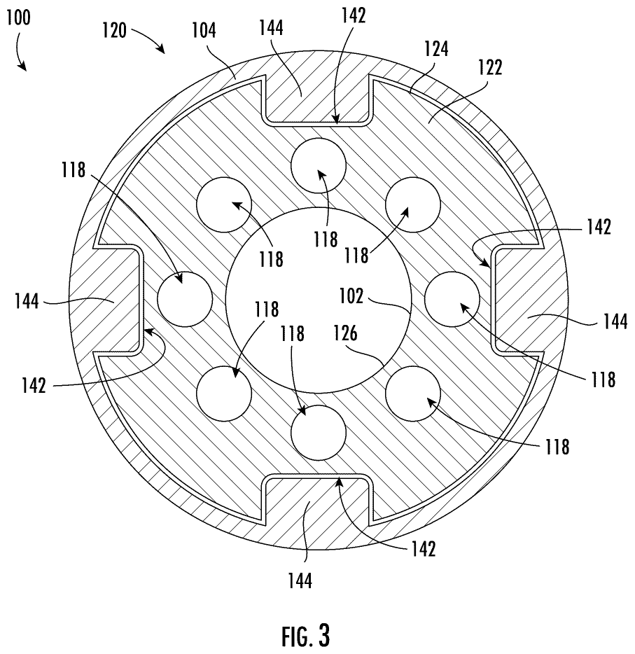

The dome 116 defines a fuel injector hole 118, shown in broken lines in FIG. 2, for receiving a fuel injector. Compressed air from the compressor section of the gas turbine engine 10 flows into the combustion chamber 110, where the compressed air is mixed with fuel from the fuel injector in the fuel injector hole and ignited to create combustion gases in the combustion chamber 110. The dome 116 may include a plurality of fuel injector holes 118 to accommodate a plurality of fuel injectors (see, e.g., FIGS. 3-5).

The dome 116 includes a forward portion 120 including an outer shoulder 121 defining a first annular surface 122. The first annular surface 122 is disposed on the forward portion 120 of the dome 116, facing the cowl 112. The forward portion 120 defines an outer diameter 124 of the forward portion 120 to an inner diameter 126 of the outer shoulder 121, and the first annular surface extends from the outer diameter 124 to the inner diameter 126. In this form, the outer diameter 124 of the forward portion 120 is an outer diameter 124 of the dome 116 as a whole because the outer shoulder 121 defines an outwardmost portion of the dome 116. The inner diameter 126 of the forward portion 120 is an inner diameter 126 of the dome 116 as a whole because the forward portion 120 includes an inwardmost portion of the dome 116.

The first annular surface 122 is “flat,” which, in this context, means a surface that has at least 90% of its total surface area having a height in the axial direction A when installed in the combustion chamber assembly 106 within 0-5% of a reference height datum defined by the specified dimensions of the surface during manufacturing. In particular, a “flat” surface has nearly no extensions or curves between the outer diameter 124 of the dome 116 and the inner diameter 126 of the dome 116. Specifically, the first annular surface 122 may have slight deviations from manufacturing tolerances, such as a 0-5% deviation from the reference flat datum, or localized regions of increased thickness, from embossments or the like. Because the first annular surface 122 is flat, a temperature across the first annular surface 122 is substantially the same, and thermal variations and stresses within the dome 116 are reduced.

The first annular surface 122 of the dome 116 is disconnected from the cowl 112, i.e., the dome 116 is spaced from the cowl 112. That is, the dome 116 and the cowl 112 do not contact or interact with each other. In such a form, an amount of the combustor dome assembly 100 inward of the cowl 112 in the radial direction R is reduced, which addresses space constraints and manufacturing challenges for the gas turbine engine 10. In particular, components with complex geometries are subject to low-cycle fatigue (LCF) stresses (such as thermal cycling stresses), and the flat shape of the dome 116 and arrangement away from the cowl 112 reduces the LCF stresses. Additionally, when the first annular surface 122 is flat, the dome 116 cools more quickly and is easier to manufacture.

The dome 116 includes an aft portion 128 including an inner shoulder 129 defining a second annular surface 130. The second annular surface 130 is disposed on the aft portion 128 of the dome 116, facing the combustion chamber 110. The aft portion 128 includes an inner surface 132 engaging the inner liner 102 and an outer surface 134 engaging the outer liner 104. The second annular surface 130 extends from the inner surface 132 to the outer surface 134. The inner shoulder 129 defines a second outer diameter 136 and a second inner diameter 138, such that the second outer diameter 136 is smaller than the outer diameter 124 and the second inner diameter 138 is greater than the inner diameter 126. The second annular surface 130 extends from the second outer diameter 136 to the second inner diameter 138. That is, the second annular surface 130 is disposed between the outer diameter 124 of the dome 116 and the inner diameter 126 of the dome 116, and thus the second annular surface 130 is shorter in the radial direction R than the first annular surface 122. The shorter second annular surface 130 allows the inner liner 102 to engage the inner surface 132 of the aft portion 128 and the outer liner 104 to engage the outer surface 134 of the aft portion 128.

As described above, the dome 116 is secured to the inner liner 102 and to the outer liner 104 with the pressurized seal. Specifically, the first annular surface 122 is sized relative to the second annular surface 130 a first air pressure on the first annular surface 122 is configured to be greater than a second air pressure on the second annular surface 130. The pressurized seal secures the dome 116 without additional fasteners or welds, reducing manufacturing and construction time for the combustor dome assembly 100.

The exemplary combustor dome assembly 100 depicted includes a ring seal 140 aft of the cowl 112 in the axial direction A. The ring seal 140 additionally secures the dome 116 to the inner liner 102 and to the outer liner 104 in conjunction with the pressurized seal. The ring seal 140 reduces or inhibits leaking of combustion gasses past the cowl 112 to the dome 116 and into the combustion chamber 110. The ring seal 140 may be a suitable material, such as an elastic polymer or an elastic metal, that seals an interface between the dome 116 and the outer liner 104 and resists the surrounding thermal environment. Alternatively, the combustor dome assembly 100 may include a different seal, such as a rope seal or a W-seal, or may not include an additional seal at all.

With reference to FIG. 3, a forward looking aft view of the combustor dome assembly 100 is provided. Specifically, the view of FIG. 3 shows the inner liner 102, the outer liner 104, and the forward portion 120 of the dome 116 including the first annular surface 122. As described above, the dome 116 includes a plurality of fuel injector holes 118 that are configured to receive a fuel injector. The fuel injector holes 118 are arranged circumferentially around the dome 116.

To reduce circumferential motion of the dome 116, the dome 116 includes a plurality of alignment slots 142 and the outer liner 104 includes a plurality of alignment tabs 144 disposed in the plurality of alignment slots 142. The plurality of alignment slots 142 are arranged along the outer diameter 124 of the dome 116 and extend radially inward. The alignment tabs 144 extend radially inward into the alignment slots 142 to reduce circumferential motion of the dome 116. The alignment tabs 144 may be secured to the dome 116 with a suitable fastening method, such as brazing, adhering, mechanical fasteners, or combinations thereof. Alternatively, the alignment tabs 144 may be positioned within the alignment slot 142 with no additional fastening.

It will be appreciated that the inner liner 102 may include the plurality of alignment tabs 144 and the plurality of alignment slots 142 may be arranged along the inner diameter 126 of the dome 116. In such a form, the plurality of alignment tabs 144 extend radially outward from the inner liner 102 into the plurality of alignment slots 142. It will also be appreciated that the dome 116 may include a plurality of alignment tabs 144 that are received by a plurality of alignment slots 142 defined in the inner liner 102 or the outer liner 104.

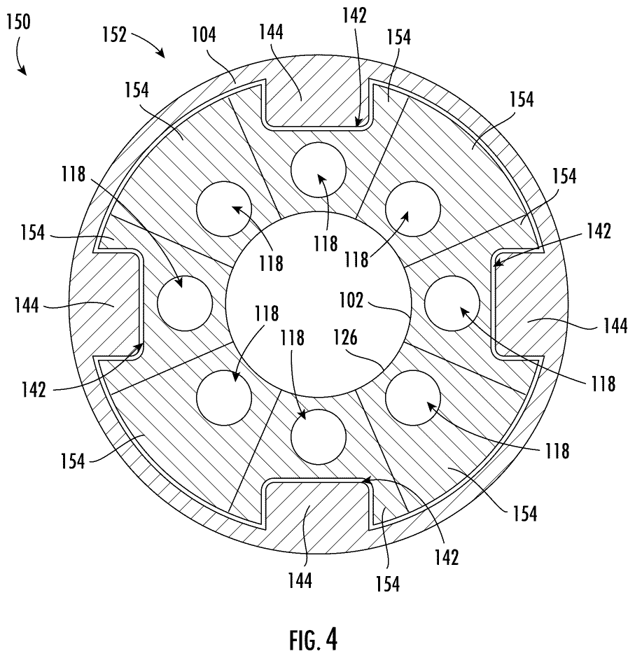

Now referring to FIG. 4, a forward looking aft view of a combustor dome assembly 150 with another dome 152 is provided. Specifically, while the dome 116 of FIGS. 1-3 is a monolithic, unitary construction, the dome 152 of FIG. 4 includes a plurality of segments 154 arranged circumferentially. Each of the plurality of segments 154 includes one of the fuel injector holes 118, and some of the plurality of segments 154 include an alignment slot 142 that receives an alignment tab 144 of the outer liner 104. The plurality of segments 154 are joined together in a suitable manner, such as brazing, fastening, adhering, and combinations thereof. By forming the dome 152 as the plurality of segments 154, each individual segment 154 may be manufactured more quickly than manufacturing an entire dome 152 at once, reducing overall manufacturing time for the combustor dome assembly 150.

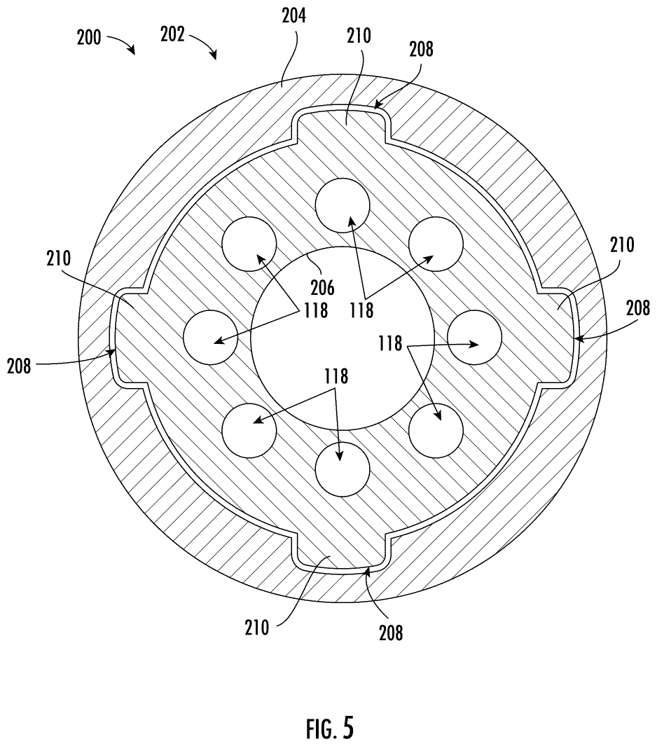

Now referring to FIG. 5, a forward looking aft view of a combustor dome assembly 200 with another dome 202 is provided. The combustor dome assembly 200 includes an outer liner 204 and an inner liner 206, and the dome 202 extends between the outer liner 204 and the inner liner 206. The outer liner 204 defines a plurality of alignment slots 208, and the dome 202 includes a plurality of alignment tabs 210 that are disposed in the plurality of alignment slots 208. The alignment tabs 210 extend outward into the alignment slots 208, securing the dome 202 to the outer liner 204. While not shown in FIG. 5, it will be appreciated that the inner liner 206 may define the alignment slots 208, and the alignment tabs 210 may extend toward the inner liner 206 in such a form.

Further aspects are provided by the subject matter of the following clauses:

A combustor dome assembly includes an outer liner, an inner liner inward of the outer liner, a dome disposed on the inner liner and the outer liner, and a cowl connected to the inner liner and to the outer liner, wherein the dome is disconnected from the cowl and defines an annular surface facing the cowl, the annular surface extending from an outer diameter of the dome to an inner diameter of the dome.

The combustor dome assembly of any of the preceding clauses, further including a ring seal securing the dome to the inner liner and to the outer liner.

The combustor dome assembly of any of the preceding clauses, wherein the dome further defines a forward portion and an aft portion, the forward portion including the annular surface, and the aft portion including an inner surface engaging the inner liner, an outer surface engaging the outer liner, and a second annular surface extending from the outer surface to the inner surface.

The combustor dome assembly of any of the preceding clauses, wherein the first annular surface is sized relative to the second annular surface such that a first air pressure on the first annular surface is configured to be greater than a second air pressure on the second annular surface.

The combustor dome assembly of any of the preceding clauses, wherein the second annular surface defines a second outer diameter and a second inner diameter, wherein the second outer diameter is smaller than the outer diameter and the second inner diameter is greater than the inner diameter.

The combustor dome assembly of any of the preceding clauses, wherein the dome defines an alignment slot and at least one of the outer liner or the inner liner includes an alignment tab disposed in the alignment slot.

The combustor dome assembly of any of the preceding clauses, wherein at least one of the outer liner or the inner liner defines an alignment slot and the dome includes an alignment tab disposed in the alignment slot.

The combustor dome assembly of any of the preceding clauses, wherein the dome is spaced from the cowl.

The combustor dome assembly of any of the preceding clauses, wherein the dome is secured to the inner liner and to the outer liner with a pressurized seal.

The combustor dome assembly of any of the preceding clauses, wherein the inner liner and the outer liner are both formed of a ceramic matrix composite (CMC) material.

The combustor dome assembly of any of the preceding clauses, wherein the cowl is formed of a metal.

The combustor dome assembly of any of the preceding clauses, wherein the cowl is connected to at least one of the outer liner or the inner liner with a pin joint.

The combustor dome assembly of any of the preceding clauses, wherein the dome is monolithic.

The combustor dome assembly of any of the preceding clauses, wherein the dome includes a plurality of segments arranged circumferentially.

A gas turbine engine includes a turbomachine including, in serial flow order, a fan section, a compressor section, a combustion section, and a turbine section, the combustion section including a combustor dome assembly including an outer liner, an inner liner, a dome disposed on the inner liner and the outer liner, and a cowl connected to the inner liner and to the outer liner, wherein the dome is disconnected from the cowl and defines an annular surface facing the cowl, the annular surface extending from an outer diameter of the dome to an inner diameter of the dome.

The gas turbine engine of any of the preceding clauses, wherein the combustor assembly further includes a ring seal securing the dome to the inner liner and to the outer liner.

The gas turbine engine of any of the preceding clauses, wherein the dome further defines a forward portion and an aft portion, the forward portion including the annular surface, and the aft portion including an inner surface engaging the inner liner, an outer surface engaging the outer liner, and a second annular surface extending from the outer surface to the inner surface.

The gas turbine engine of any of the preceding clauses, wherein the dome defines an alignment slot and at least one of the outer liner or the inner liner includes an alignment tab disposed in the alignment slot.

The gas turbine engine of any of the preceding clauses, wherein at least one of the outer liner or the inner liner defines an alignment slot and the dome includes an alignment tab disposed in the alignment slot.

The gas turbine engine of any of the preceding clauses, wherein the dome is configured to be secured to the inner liner and to the outer liner with a pressurized seal.

This written description uses examples to disclose the present disclosure, including the best mode, and also to enable any person skilled in the art to practice the disclosure, including making and using any devices or systems and performing any incorporated methods. The patentable scope of the disclosure is defined by the claims, and may include other examples that occur to those skilled in the art. Such other examples are intended to be within the scope of the claims if they include structural elements that do not differ from the literal language of the claims, or if they include equivalent structural elements with insubstantial differences from the literal languages of the claims.

1. A combustor dome assembly comprising:
an outer liner;
an inner liner inward of the outer liner;
a dome disposed on the inner liner and the outer liner; and
a cowl connected to the inner liner and to the outer liner;
wherein the dome is disconnected from the cowl and defines an annular surface facing the cowl, the annular surface extending from an outer diameter of the dome to an inner diameter of the dome.

2. The combustor dome assembly of claim 1, further comprising a ring seal securing the dome to the inner liner and to the outer liner.

3. The combustor dome assembly of claim 1, wherein the annular surface comprises a first annular surface, wherein the dome further defines a forward portion and an aft portion, the forward portion including the first annular surface, and the aft portion including an inner surface engaging the inner liner, an outer surface engaging the outer liner, and a second annular surface extending from the outer surface to the inner surface.

4. The combustor dome assembly of claim 3, wherein the first annular surface is sized relative to the second annular surface such that a first air pressure on the first annular surface is configured to be greater than a second air pressure on the second annular surface.

5. The combustor dome assembly of claim 3, wherein the second annular surface defines a second outer diameter and a second inner diameter, wherein the second outer diameter is smaller than the outer diameter and the second inner diameter is greater than the inner diameter.

6. The combustor dome assembly of claim 1, wherein the dome defines an alignment slot and at least one of the outer liner or the inner liner includes an alignment tab disposed in the alignment slot.

7. The combustor dome assembly of claim 1, wherein at least one of the outer liner or the inner liner defines an alignment slot and the dome includes an alignment tab disposed in the alignment slot.

8. The combustor dome assembly of claim 1, wherein the dome is spaced from the cowl.

9. The combustor dome assembly of claim 1, wherein the dome is configured to be secured to the inner liner and to the outer liner with a pressurized seal.

10. The combustor dome assembly of claim 1, wherein the inner liner and the outer liner are both formed of a ceramic matrix composite (CMC) material.

11. The combustor dome assembly of claim 1, wherein the cowl is formed of a metal.

12. The combustor dome assembly of claim 1, wherein the cowl is connected to at least one of the outer liner or the inner liner with a pin joint.

13. The combustor dome assembly of claim 1, wherein the dome is monolithic.

14. The combustor dome assembly of claim 1, wherein the dome includes a plurality of segments arranged circumferentially.

15. A gas turbine engine comprising:
a turbomachine including, in serial flow order, a fan section, a compressor section, a combustion section, and a turbine section, the combustion section including a combustor dome assembly comprising:
an outer liner;
an inner liner inward of the outer liner;
a dome disposed on the inner liner and the outer liner; and
a cowl connected to the inner liner and to the outer liner;
wherein the dome is disconnected from the cowl and defines an annular surface facing the cowl, the annular surface extending from an outer diameter of the dome to an inner diameter of the dome.

16. The gas turbine engine of claim 15, wherein the combustor assembly further comprises a ring seal securing the dome to the inner liner and to the outer liner.

17. The gas turbine engine of claim 15, wherein the dome further defines a forward portion and an aft portion, the forward portion including the annular surface, and the aft portion including an inner surface engaging the inner liner, an outer surface engaging the outer liner, and a second annular surface extending from the outer surface to the inner surface.

18. The gas turbine engine of claim 15, wherein the dome defines an alignment slot and at least one of the outer liner or the inner liner includes an alignment tab disposed in the alignment slot.

19. The gas turbine engine of claim 15, wherein at least one of the outer liner or the inner liner defines an alignment slot and the dome includes an alignment tab disposed in the alignment slot.

20. The gas turbine engine of claim 15, wherein the dome is configured to be secured to the inner liner and to the outer liner with a pressurized seal.
